(19) United States
(12) Patent Application Publication
(10) Pub. No.: US 2011/0080457 A1
(43) Pub. Date: Apr. 7, 2011

(54) INKJET PRINTER AND FILTER FOR AN INKJET PRINTER

(76) Inventors: Toshihide Nagamine, Toukai (JP); Takahiro Arima, Hitachi (JP); Takehiko Matsushita, Hitachi (JP)

(21) Appl. No.: 12/862,404

(22) Filed: Aug. 24, 2010

(30) Foreign Application Priority Data
Oct. 2, 2009 (JP) 2009-230159

(51) Int. Cl. B41J 2/175

(52) U.S. Cl. 347/93

(57) ABSTRACT

An inkjet printer is provided having a filter that is replaceable efficiently and quickly and capable of reducing the possibility of contamination of an operator's hands and ambient surroundings. The filter includes a pipe connecting port which is connected in a channel through which ink or solvent flows and communicates with a primary side and a secondary side of an element of the filter. A channel block is provided with a housing cavity. A filter case is accommodated in the housing cavity and holds the filter element. The filter case is not connected with a pipe to the channel block. The filter case is detachable from the channel block, and a securing unit secures the filter case to the channel block.

### RELATED APPLICATIONS

This application claims the benefit of priority from Japanese Application No. JP-2009-230159 filed on Oct. 2, 2009 entitled “Inkjet Recording Apparatus,” the disclosure of which also is entirely incorporated herein by reference.

### TECHNICAL FIELD

The present discussion relates to an inkjet printers having filters with characteristic structures for use in removing particulates in ink and solvent circulating channels.

### BACKGROUND

An inkjet printer produces printed output by ejecting ink from a nozzle having a diameter of from 40 μm to 100 μm to transform the ink into droplets. If such a small-diameter nozzle is clogged with particulates, proper ejection of the ink from the nozzle is hindered and the inkjet printer cannot continue printing. To avoid nozzle clogging, multiple filters are placed on channels, through which ink and solvent circulate, in the inkjet printer.

Typical filters include a main ink filter located on a channel used to supply ink to the nozzle, a solvent filter located on a solvent supply channel, and a recovery filter located on a recovery channel that collects ink droplets ejected from the nozzle but not used.

Filters may gradually become clogged over time and block the flow of liquid, and hence require periodical replacement.

Various types of filters have been developed in consideration of installability and replaceability. Examples include: a filter in a housing with a primary side, which liquid flows into, and a secondary side, from which the liquid flows out, connected with pipes; a filter with one of the primary and secondary sides connected with a pipe to a housing and the other side directly connected to a manifold having a channel therein provided with multiple components; and a filter with primary and secondary sides directly connected to a manifold.

Filter replacement is done by replacing a housing including a filter or by replacing only a filter from a disassembled housing (e.g., see JP-A-2001-146020A).

### SUMMARY

Since the inkjet printer in this description is a printing apparatus which produces printed output on products that are continuously mass-manufactured on a production line, filter replacement involving an operation halt of the apparatus causes a downtime for the production line. The more time is required to replace the filter, the greater the production efficiency is compromised.

In addition, for inkjet printers often used on a production line of products, which require to be manufactured under strictly-controlled, hygienic conditions, such as food, beverages, chemical agents and cosmetics, contamination of the interior of the inkjet printer, peripheral facilities, floors and an operator's hands with ink and diffusion of ink odor to ambient surroundings, represent problems that may be caused by filter replacement.

More specifically, in many cases, when a pipe is pulled off from a housing including a filter, ink is spilled from the end of the pipe or the pipe connecting port of the housing, ink is spilled from the housing that was disassembled to remove the filter embedded therein, or ink adheres to the hands of an operator removing the filter from a disassembled housing.

The present subject matter has been made to provide an inkjet printer including a filter that can be replaced effectively in a short time.

In addition, the present subject matter has been made to provide an inkjet printer including a filter that can reduce the possibilities of contaminating an operator's hands or ambient surroundings with ink.

For the purpose of solving the above described problems, a filter is provided in an example of an inkjet printer. The exemplary apparatus produces a printed output on an object being printed by ejecting pressurized ink from a nozzle, transforming the ink into droplets at a constant frequency by vibrating the nozzle at a constant frequency, applying an electric charge to ink droplets corresponding to dots to be printed in the transformed ink droplets by applying a charge voltage in synchronization with the frequency of the droplet transformation to a charging electrode based on output information to be printed, deflecting the ink droplets applied with the electric charge in an electric field produced by applying a direct voltage to deflection electrodes, collecting ink droplets, which correspond to dots not to be printed and are not charged, by a gutter, and relatively moving the object being printed approximately orthogonal to a deflected direction of the charged ink droplets. The inkjet printer includes a pipe connecting port which is placed on a channel through which ink or solvent flows and communicates with a primary side and a secondary side of the filter. A channel block which is provided with a housing cavity. A filter case, is accommodated in the housing cavity, holds a filter element. The filter case is not connected with a pipe to the channel block and is detachable from the channel block. A securing unit secures the filter case to the channel block.

Accordingly, the present teaching can provide an inkjet printer that enables quicker and more efficient filter replacement.

Furthermore, according to the present teaching, an inkjet printer can be provided that enables filter replacement less chance of ink contamination of the operator's hands and ambient surroundings.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed example discussed below.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a perspective view of the main body and printhead of an inkjet printer;

FIG. 2 is a perspective view showing the use of the inkjet printer;

FIG. 3 is a channel diagram of an inkjet printer according to an example;

FIG. 4 is a perspective view illustrating basic operations of the inkjet printer;

FIG. 5 is a functional block diagram of the inkjet printer;

FIG. 6 is a front view showing a filter structure of the inkjet printer according to the example;

FIG. 7 is an exploded perspective view showing the filter structure of the inkjet printer according to the example;

FIG. 8 is another exploded perspective view showing the filter structure of the inkjet printer according to the example;

FIG. 9 is a cross-sectional view of a channel block of the inkjet printer according to the example; and

FIG. 10 is a cross-sectional view showing the filter structure of the inkjet printer according to the example.

### DETAILED DESCRIPTION

While we have shown and described an example in accordance with our subject matter below, it should be understood that disclosed example is susceptible of changes and modifications without departing from the scope of the subject matter. Therefore, we do not intend to be bound by the details shown and described herein but intend to cover all such changes and modifications a fall within the ambit of the appended claims.

With reference to an illustrated example, an example will be described below; however, the present subject matter is not limited to the illustrated example.

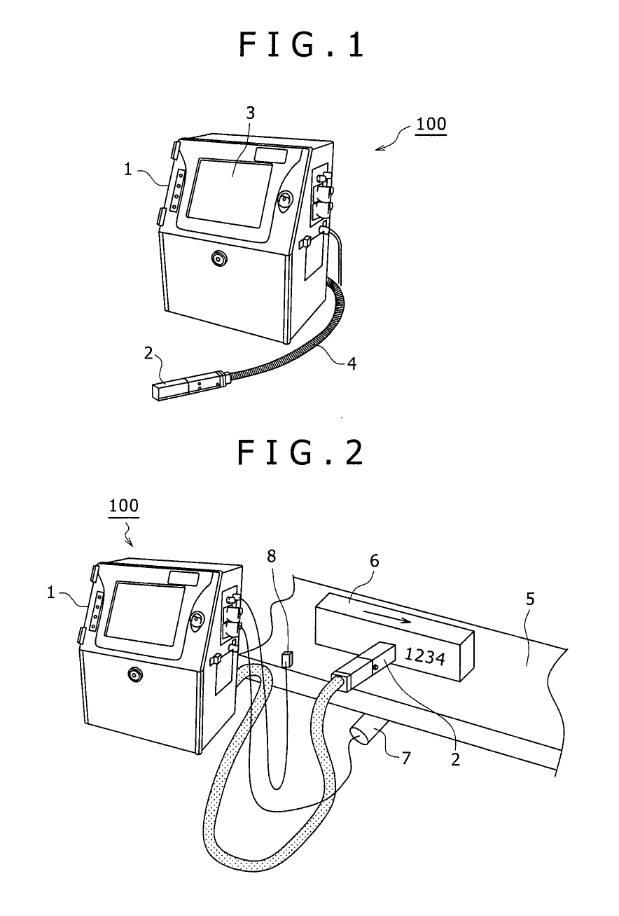

FIG. 1 is an overall view of an inkjet printer 100 according to an example. The inkjet printer 100 includes a main body 1 provided with an externally mounted operation display 3 and a printhead 2. The main body 1 is connected to the printhead 2 with a cable 4.

FIG. 2 shows an example when the inkjet printer 100 is actually being used. The inkjet printer 100 is installed on a production line in a factory that manufactures, for example, food products and beverages. The main body 1 is situated in a range where a user can operate the apparatus, while the printhead 2 is placed adjacent to a print object 6 conveyed on the production line such as a belt conveyer 5.

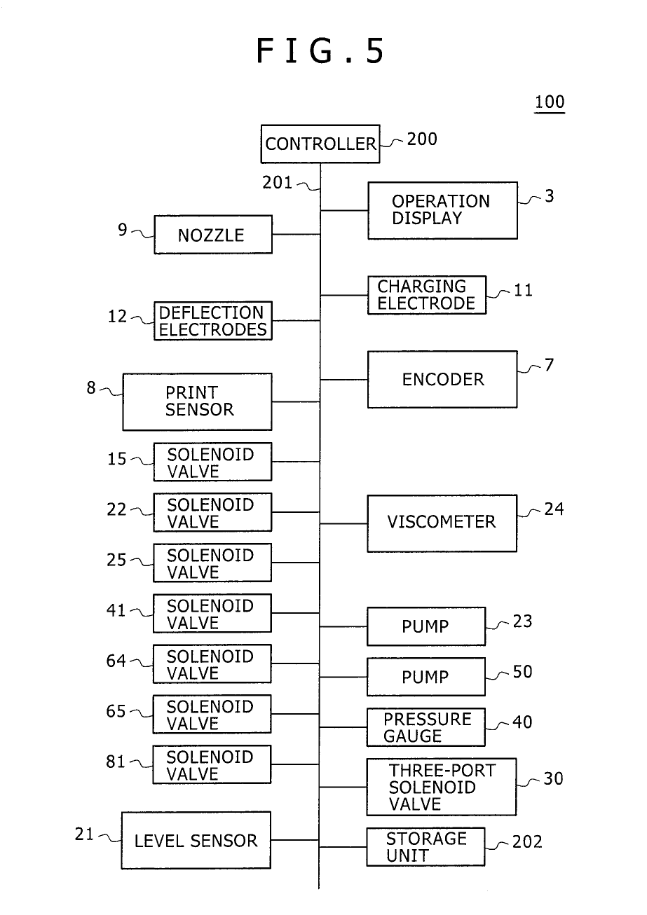

At the production line or belt conveyer 5, an encoder 7 outputs signals to the inkjet printer 100 in accordance with a conveying speed; and a print sensor 8, which detects the print object 6 and outputs signals instructing to print characters to the inkjet printer 100. The encoder 7 and print sensor 8 are used in order to print the characters at a constant width irrespective of the conveying speed, and both are connected to a controller 200 (shown in FIG. 5) in the main body 1.

In response to the signals from the encoder 7 and print sensor 8, the controller 200 controls the amount of charge and timing for charging the ink droplets 10 propelled from the nozzle 9 so that the charged and deflected ink droplets 10 adhere to the print object 6 while the print object 6 passes in the vicinity of the printhead 2. In this manner, the inkjet printer performs printing operations.

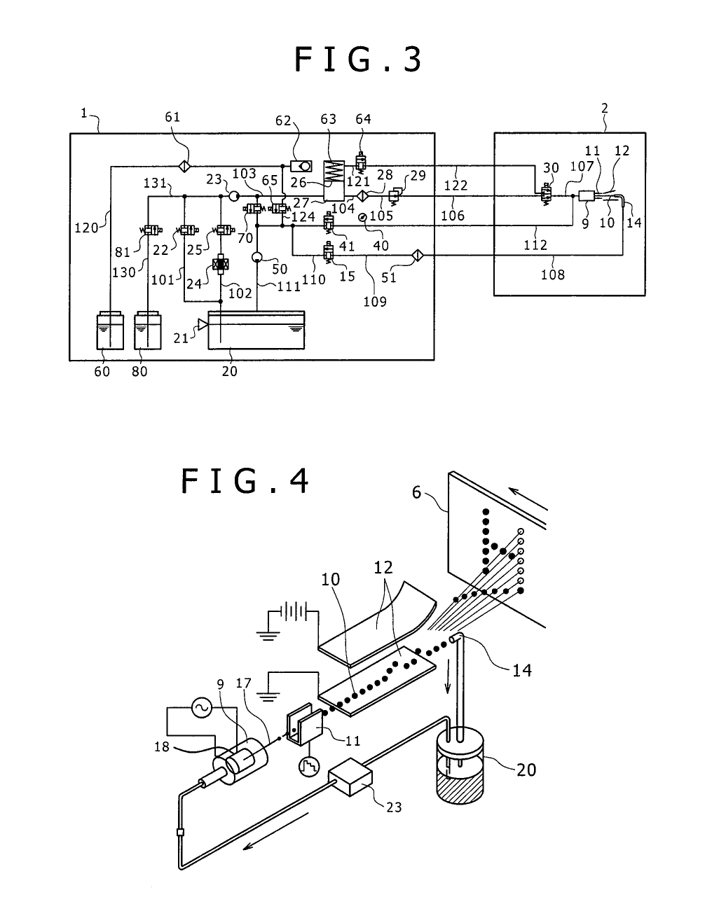

FIG. 3 shows the entire channel structure of the inkjet printer 100. The main body 1 includes a main ink reservoir 20 containing ink that circulates through channels. The main ink reservoir 20 is provided with a level sensor 21 that senses whether the fluid in the main ink reservoir 20 reaches the reference fluid level which reflects that there is a proper amount of fluid in the reservoir 20. Extending from the main ink reservoir 20 is a channel 101 that is opened and closed by a solenoid valve 22. The ink is generally sucked by a supply pump 23 through the channel 101. However, only when ink viscosity measurement is required, the ink is sucked by the supply pump 23 through a bypass channel 102 on which a viscometer 24 is placed in order to refresh the ink being measured. The viscometer 24 may be a falling type viscometer for measuring the viscosity of the ink.

The viscometer 24 is connected to a solenoid valve 25 via the channel 102. The solenoid valve 25 closes and opens the channel 102. The secondary side of the solenoid valve 25 is connected to the pump 23, which sucks and feeds the ink with pressure, via the channel 101. The pump 23 is connected via a channel 103 to an ink chamber 27 in which the pressurized ink applies pressure to a solvent through a diaphragm 26. The ink applied, with pressure by the supply pump 23 pressurizes the solvent in a solvent chamber 63 through the diaphragm 26, thereby supplying the solvent to the printhead 2. The ink chamber 27 is connected to an ink filter 28, which removes particulates in the ink, via a channel 104.

The ink filter 28 is connected to a pressure-reducing valve 29, which adjusts the pressure of the ink pushed out by the pump 23 to a pressure suitable for printing, via a channel 105. The pressure-reducing valve 29 is connected to the primary side of a three-port solenoid valve 30 in the printhead 2 via an ink supply channel 106 running in the cable 4. The secondary side of the three-port solenoid valve 30 is connected to a nozzle 9, which has a discharge orifice from which the ink is discharged, via a channel 107. The three-port solenoid valve 30 has two ports on the primary side and one port on the secondary side and is designed to selectively switch back and forth between the primary ports to communicate with the secondary port. An ink supply channel 106 is connected to the normally closed port, while a solvent supply channel 122 is connected to the normally open port.

The channel 107 on the secondary side of the three-port solenoid valve 30 branches off before the nozzle 9 to connect with a suction channel 112. The suction channel 112 passes through inside the cable 4 and a pressure gauge 40 for measuring the pressure of the ink and is connected to a solenoid valve 41. The secondary side of the solenoid valve 41 is connected to a recovery pump 50 that fills up ink through the suction channel 112 and performs sucking operations when the discharge orifice of the nozzle 9 is clogged.

Along the direction where the ink is discharged from the nozzle 9 placed is a charging electrode 11 that applies electric charge to the ink droplets 10 ejected from the nozzle 9 in an amount according to character information to be printed. In the direction where the ink droplets 10 charged by the charging electrode 11 are flying, deflection electrodes 12 are placed which create an electric field that deflects the charged ink droplets 10.

Ahead of the deflection electrodes 12 in the direction in which the ink flies, a gutter 14 is placed that captures the ink droplets 10 that are not used for printing and fly straight without being charged and deflected.

The gutter 14 is connected to a recovery filter 51, which is placed in the main body 1 and used to remove particulates contained in the ink, via a recovery channel 108 running through the cable 4. The recovery filter 51 is connected to a solenoid valve 15, which opens and closes the recovery channel, via a channel 109 and further is connected to a recovery pump 50, which sucks the ink droplets 10 captured by the gutter 14, via a channel 110. The recovery pump 50 feeds the sucked ink to the main ink reservoir 20 through a channel 111.

In addition, the main body 1 includes a solvent reservoir 60 containing solvent used to clean the nozzle 9 at stop time and to adjust the viscosity of the ink. The solvent reservoir 60 is connected to a solvent filter 61, which removes particulates in the solvent channel, via a channel 120 and is further connected to a solvent chamber 63, which sucks the solvent in and feeds the solvent with pressure, via a check valve 62, which prevents backflow of the solvent. The solvent chamber 63 is connected to a solenoid valve 64 via a channel 121. The secondary side of the solenoid valve 64 is connected to the primary port of the three-port solenoid valve 30 via the solvent supply channel 122 running through the cable 4. The channel 120 through which the solvent is sucked from the solvent reservoir 60 is connected to a solenoid valve 65 via a channel 123. The solenoid valve 65 is connected to the recovery pump 50 via a channel 124.

The main body 1 further includes an auxiliary ink reservoir 80 containing refill ink. The auxiliary ink reservoir 80 is connected to a solenoid valve 81 via a channel 130. The solenoid valve 81 is used to open and close the channel 130. The solenoid valve 81 is connected to the supply pump 23 via a channel 131.

Descriptions now will be made about the operating principles of the inkjet printer 100. The inkjet printer 100 illustrated in FIG. 4 is identical to the inkjet printer 100 shown in FIG. 1, but FIG. 4 shows only components necessary to this description of the operating principles.

As shown in FIG. 4, the ink in the main ink reservoir 20 is sucked and applied with pressure by the pump 23 and is ejected in the form of an ink column from the nozzle 9. The nozzle 9 includes an electrostriction element 18 that vibrates the ink at a predetermined frequency to transform the ink column 17 ejected from the nozzle 9 into droplets. The number of generated ink droplets 10 in this manner is dependent on the frequency of the excitation voltage applied to the electrostriction element 18, resulting in the same number as the frequency. The ink droplet 10 is charged by applying voltage in an amount according to character information to the charging electrode 11. While an ink droplet 10 charged by the charging electrode 11 is flying in the electric field between deflection electrodes 12, the ink droplet 10 is deflected by the force in proportion to the amount of electric charge. Then, the ink droplet 10 flies and lands on the print object 6. The amount of charge determines the deflection direction of the ink droplet 10, and therefore the position where the ink droplet 10 lands varies in accordance with the amount of charge. Moving the print object 6 by the production line in a direction orthogonal to the deflection direction allows ink droplets to land in the direction orthogonal to the deflection direction, thereby forming a character with the multiple landed droplets.

The ink droplets 10 that were not used for printing fly straight between the deflection electrodes 12 and are captured by the gutter 14. Then the ink droplets 10 pass through the recovery channel 108 and are collected in the main ink reservoir 20.

FIG. 5 is a functional block diagram of the inkjet printer 100. The inkjet printer 100 includes a controller 200 provided with, for example, a master processing unit (MPU). The controller 200 controls components including the operation display 3, nozzle 9, charging electrode 11, deflection electrodes 12, encoder 7, print sensor 8, viscometer 24, solenoid valves 15, 22, 25, 41, 64, 65, 81, pumps 23, 50, three-port solenoid valve 30, level sensor 21, pressure gauge 40 and a storage unit 202 via a bus line 201.

The storage unit 202 stores a program for controlling the inkjet printer 100, and therefore the controller 200 controls each component included in the inkjet printer 100 based on the program.

Following are descriptions about effects of the present teaching according to the example.

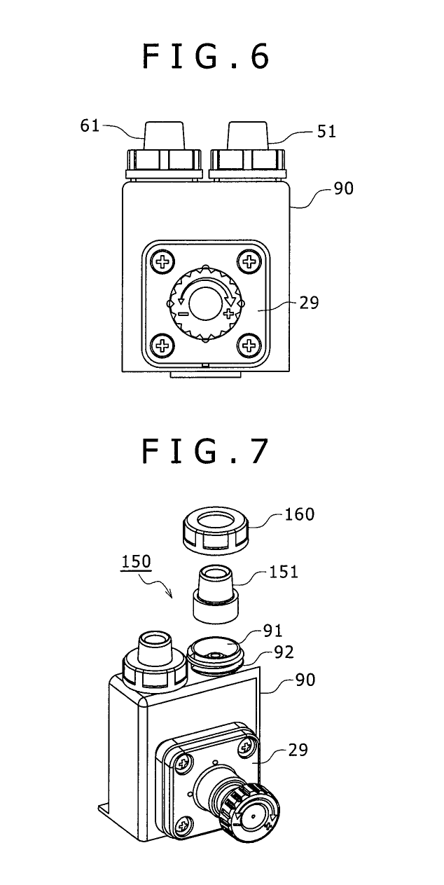

FIG. 6 shows a channel block 90 having a recovery filter 51 and a solvent filter 61 integrally connected to the top face thereof and a pressure-reducing valve 29 integrally connected to the front face thereof. The recovery filter 51 and solvent filter 61 are identical in structure, and descriptions hereinafter will be made for only the recovery filter 51.

Projecting upwardly from the top face of the channel block 90, as shown in FIG. 7, is a wall that defines a housing cavity 91 for housing a filter case 150 therein. That wall also has a thread 92 on the outside, for engaging with a securing nut 160.

The filter case 150 having an outer circumference slightly smaller than the inner circumference of the housing cavity 91 is placed in the housing cavity 91. The filter case 150 is fixed with the securing nut 160 so as to be pushed against the channel block 90, but can be detached in the upward direction from the channel block 90 by disengaging the securing nut 160. The filter case 150 is integrally provided with a grip 151 that allows a user's hand to handle the filter case 150 without touching the ink-contact area of the filter case 150.

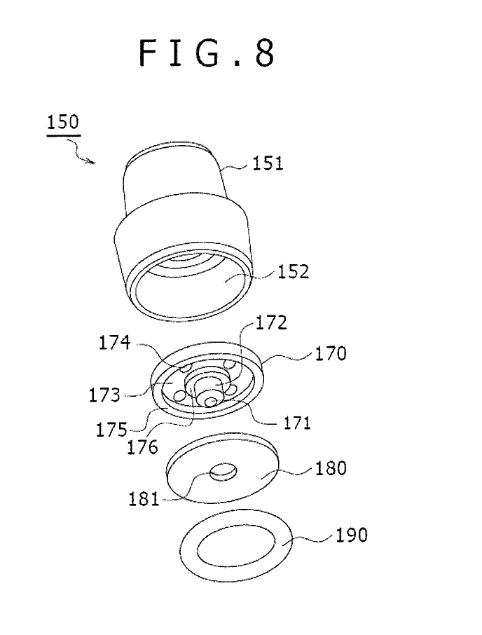

As shown in FIG. 8, the filter case 150 has an opening 152 that houses a holder 170, a filter 180 and an O-ring 190.

The holder 170 includes a through hole 171 and a projection 172 at the center, a circular groove 173 and four through holes 174 penetrating from the bottom of the groove 173 to the back side of the holder 170. The outer face 175 and inner face 176 defining the groove 173 are flush with each other and abut against the filter 180. The outside diameter of the holder 170 is designed so that a clearance between the holder 170 and the opening 152 of the filter case 150 becomes small for easy assembly; however, the holder 170 is properly press-fitted in the opening 152.

The filter 180 is a flat metal mesh filter and achieves a filter rating of 75 μm. The outer circumference of the filter 180 fits in the filter case 150 so that the clearance between the filter 180 and opening 152 becomes small. At the center provided is a through hole 181 through which the projection 172 of the holder 170 passes.

The O-ring 190 not only enhances sealing performance between the channel block 90 and filter case 150, but also plays a role in holding the holder and filter in the filter case 150. The outside circumference dimension of the O-ring 190 is designed so as to be greater than the circumference of the opening 152 of the filter case 150 by a few percent. When the O-ring 190 is housed, the dimension allows the O-ring 190 to retain the housed components on its own elasticity causing the O-ring 190 to stretch outwardly.

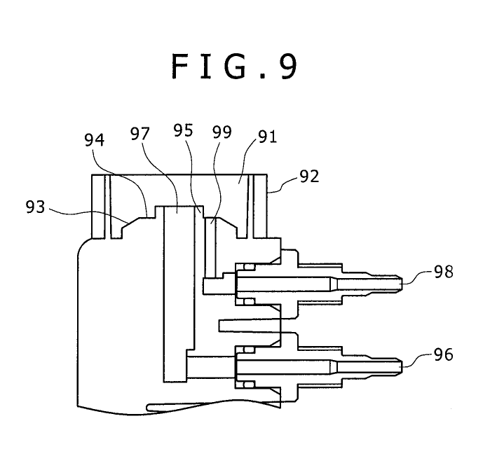

As shown in FIG. 9, inside the housing cavity 91 of the channel block 90 there are a slanting seal face 93, which abuts against the O-ring 190, a flat portion 94, a projecting portion 95 raised from the flat portion 94, a first channel hole 97, which is formed in the center of the projecting portion 95, receives the projection 172 of the holder 170 and is connected to a primary externally-connecting pipe joint 96, and a second channel hole 99, which is formed in the flat portion 94 and is connected to a secondary externally-connecting pipe joint 98.

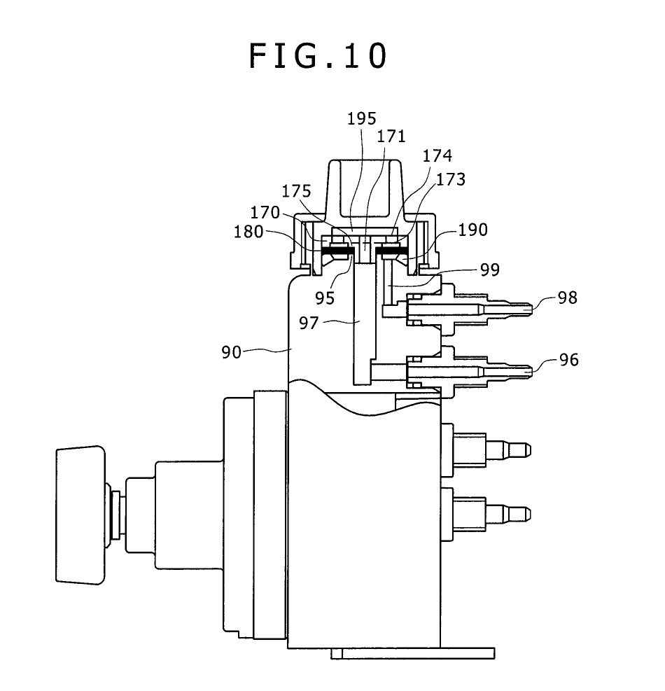

With reference to FIGS. 9 and 10, an exemplary liquid flow is illustrated. Liquid enters the channel block 90 from the primary externally-connecting pipe joint 96, goes up the first channel hole 97, passes through the through hole 171 of the holder, goes through a cylindrical channel 195 between the filter case 150 and holder 170, falls into the four through holes 174 and the groove 173 to reach the top face (primary side) of the filter 180, and passes through the filter 180 with particulates removed. The liquid having reached the filter 180 always passes through the filter 180 toward the secondary side, because the filter 180 is in close contact with the O-ring 190 at the outer side and abuts against both the inner face 176 of the holder 170 and the top face of the projecting portion 95 of the channel block 90 at the inner side. After passing through the filter 180, the liquid reaches the secondary externally-connecting pipe joint 98 via the second channel hole 99.

Next, description of a filter replacement procedure will be made, with reference to FIGS. 7 and 8. The securing nut 160 secured to the channel block 90 is loosened and removed by hand. Then, the filter case 150 released from the secured state is pulled up with the grip 151 by hand to remove the filter case 150 from the housing cavity 91 of the channel block 90. At this time, as shown in FIG. 8, the filter case 150 is removed together with the filter 180, holder 170 and O-ring 190 from the housing cavity 91 of the channel block 90.

Even in a state where the securing nut 160, filter case 150 and filter 180 are removed, the liquid will not spill from the housing cavity 91 of the channel block 90 thanks to the upward-facing opening at the top of the housing cavity 91.

Subsequently, a new filter case 150 is placed in the housing cavity 91 of the channel block 90. The new filter case 150 holding a filter 180, holder 170 and O-ring 190 is attached all together in the channel block 90.

At last, the new filter case 150 is secured in the channel block 90 by tightening the removed securing nut 160 by hand. The O-ring 190 compressed between the channel block 90 and filter case 150 ensures sealing performance.

Although the filter has a primary side and secondary side in the example, the liquid can be set to flow in any direction, either of the externally-connecting pipe joints can be the primary or secondary.

As shown and described, each filter case with the filter element and O-ring is detachably mounted to the respective housing cavity on the channel block by a securing nut and a thread on the respective housing. However, neither filter case is directly connected to any of the pipes for the ink or solvent channels of the inkjet printer. As a result, each filter case is configured for attachment in and detachment from the respective housing cavity, without the need for attachment and detachment of the filter case to the pipes of the respective ink or solvent channel of the inkjet printer. Consequently, it is not necessary to disconnect and connect any pipe to remove and replace a filter.

According to the above-described structure, production line downtime required to replace a filter can be reduced, thereby improving production efficiency.

In addition, the example of the teaching eliminates the necessity of pipe disconnection and disassembly of filter housings during filter replacement operations, thereby significantly reducing ink contamination of the interior of the inkjet printer, peripheral facilities, floors and an operator's hands.

Furthermore, reduction of replacement time and ambient contamination with ink can decrease diffusion of ink odor to ambient surroundings.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. An inkjet printer that produces a printed output on an object being printed by ejecting pressurized ink from a nozzle, transforming the ink into droplets at a constant frequency by vibrating the nozzle at a constant frequency, applying an electric charge to ink droplets corresponding to dots to be printed in the transformed ink droplets by applying a charge voltage in synchronization with the frequency of the droplet transformation to a charging electrode based on output information to be printed, deflecting the ink droplets applied with the electric charge in an electric field produced by applying a direct voltage to deflection electrodes, collecting ink droplets, which correspond to dots not to be printed and are not charged, by a gutter, and relatively moving the object being printed approximately orthogonal to a deflected direction of the charged ink droplets, the inkjet printer having a filter structure comprising:
a pipe connecting port which is connected in a channel of the printer through which ink or solvent flows and communicates with a primary side and a secondary side of the filter structure;
a channel block provided with a housing cavity;
a filter case which is accommodated in the housing cavity and holds a filter element and is detachable from the channel block, the filter case not being directly connected to any pipe of the channel of the printer; and
a securing unit which secures the filter case to the channel block.

2. The inkjet printer according to claim 1, wherein the filter element is shaped as a disk and has a through hole at the center, the through hole serving as a channel not for filtration.

3. The inkjet printer according to claim 1, wherein the filter element is housed in the filter case and is held with an elastic body, which seals the filter element off from the outside, so as not to be dropped off from the filter case.

4. The inkjet printer according to claim 1, wherein the housing cavity, which is integrally provided in the channel block and accommodates the filter case, has an opening that faces upward.

5. The inkjet printer according to claim 1, wherein the filter case includes a protrusion which is used as a grip to attach or detach the filter case from the channel block.

6. The inkjet printer according to claim 1, wherein the filter is placed on a channel which sucks and collects ink captured by the gutter.

7. The inkjet printer according to claim 1, wherein the filter is placed on a solvent supply channel between a solvent reservoir containing the solvent and the nozzle.

8. A filter structure for an inkjet printer, comprising:
a channel block having one or more ports connectable to a pipe of a solvent or ink channel of the printer to provide a flow of solvent or ink to and from the channel block;
the channel block further having a housing cavity coupled to the one or more ports;
a filter case holding a filter element and configured to be accommodated in the housing cavity, the filter case being configured for attachment in and detachment from the housing cavity without direct attachment and detachment of the filter case to any pipe of the inkjet printer; and
a securing unit for detachably securing the filter case to the channel block.

9. A filter structure for filtering ink and solvent in an inkjet printer, comprising:
a channel block comprising:
a first pair of ports connectable to pipes of an ink channel of the inkjet printer to provide a flow of ink to and from the channel block;
a first housing cavity coupled to the first pair of ports; and
a second pair of ports connectable to pipes of a solvent channel of the inkjet printer to provide a flow of solvent to and from the channel block;
a second housing cavity coupled to the second pair of ports;
a first filter case configured to be accommodated in the first housing cavity, the first filter case holding a first filter element for filtering ink, and the first filter case being configured for attachment in and detachment from the housing cavity without attachment and detachment of the filter case to the pipes of the ink channel of the inkjet printer;
a securing unit for detachably securing the first filter case to the channel block when accommodated in the first housing cavity;
a second filter case configured to be accommodated in the second housing cavity, the second filter case holding a second filter element for filtering solvent, and the second filter case being configured for attachment in and detachment from the housing cavity without attachment and detachment of the filter case to the pipes of the ink channel of the inkjet printer; and
a securing unit for detachably securing the second filter case to the channel block when accommodated in the second housing cavity.
